(19) United States
(12) Patent Application Publication
(10) Pub. No.: US 2013/0305693 A1
(43) Pub. Date: Nov. 21, 2013

(54) Exhaust Gas Recirculation Device for an Internal Combustion Engine

(71) Applicant: MANN+HUMMEL GMBH, Ludwigsburg (DE)

(72) Inventors: Michael Heim, Freiberg a. N. (DE); Andrew Glynn, Bad Schoenborn (DE)

(73) Assignee: MANN+HUMMEL GMBH, Ludwigsburg (DE)

(21) Appl. No.: 13/947,481

(22) Filed: Jul. 22, 2013

Related U.S. Application Data
(63) Continuation of application No. PCT/EP2012/051089, filed on Jan. 25, 2012.

(30) Foreign Application Priority Data
Jan. 31, 2011 (DE) 10 2011 009 916.6

(51) Int. Cl. F02M 25/07

(52) U.S. Cl. CPC F02M 25/074
USPC 60/278; 123/568.21

(57) ABSTRACT

An exhaust gas recirculation device for an internal combustion engine includes a return line, which branches off an exhaust tract and leads into an intake tract. A separator component is arranged in the return line. Downstream of the separator component, a gas line, via which additional gas can be supplied, leads into the return line.

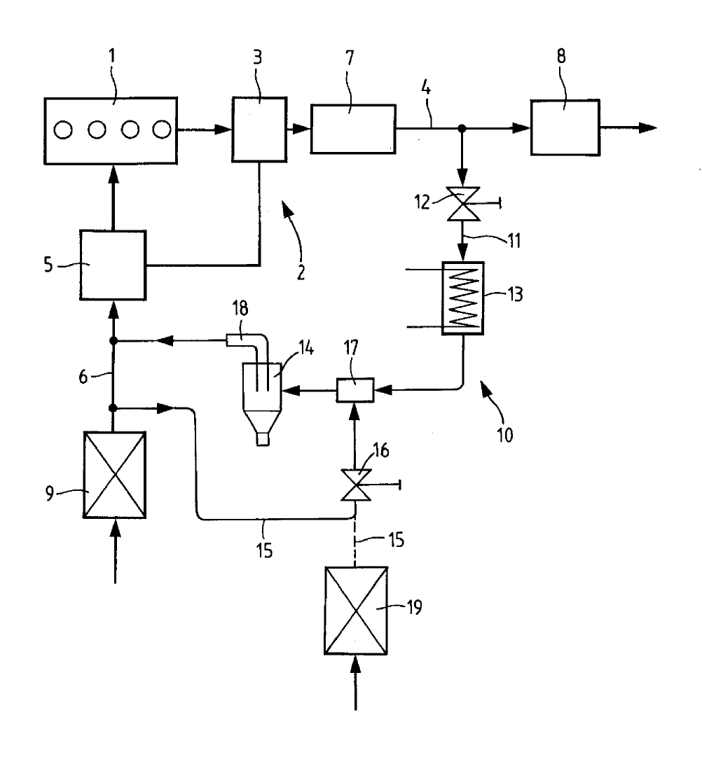

### CROSS REFERENCE TO RELATED APPLICATIONS

This application is U.S. bypass continuation of international patent application no. PCT/EP2012/051089, filed Jan. 25, 2012 designating the United States of America, the entire disclosure of which is incorporated herein by reference. PCT/EP2012/051089 claims priority to German patent application no. 10 2011 009 916.6, filed Jan. 31, 2011.

### TECHNICAL FIELD

The invention concerns an exhaust gas recirculation device for an internal combustion engine.

### BACKGROUND

EP 2 199 585 A1 discloses a charged internal combustion engine that is provided with an exhaust gas recirculation device. The exhaust gas recirculation device comprises a return line that is branching off downstream of an exhaust gas purification unit in the exhaust gas manifold of the internal combustion engine and opens into the intake manifold upstream of a compressor which is a component of an exhaust gas turbo charger. The exhaust gas turbine of the exhaust gas turbocharger is arranged upstream of the exhaust gas purification unit in the exhaust gas manifold.

In the return line an adjustable valve and as well as an exhaust gas cooling device are arranged by means of which the exhaust gas is cooled to lower temperatures before being introduced into the intake manifold. Moreover, in the return line a cyclone separator is arranged by means of which particles are separated which are entrained in the gas flow through the return line. Such particles, originating for example from the exhaust gas purification unit, can cause damage of the motor as well as of the exhaust gas turbocharger.

The invention has the object to separate with simple measures and in an efficient way particles from the gas flow that is being passed through an exhaust gas recirculation device of an internal combustion engine.

### SUMMARY OF THE INVENTION

The exhaust gas circulation device according to the invention is used in internal combustion engines and serves for returning a portion of the exhaust gas flow from the exhaust gas manifold of the internal combustion engine into the intake manifold in order to improve the exhaust gas behavior and consumption behavior of the internal combustion engine.

In a return line of the exhaust gas recirculation device there is a separator component which serves to separate particles that are entrained with the exhaust gas flow through the return line in order to prevent damage to the internal combustion engine or other components correlated with the internal combustion engine. The entrained particles are enlarged by a so-called heterogeneous condensation in that, by a drop below the dew point, water droplets will aggregate by condensation on the particles so that as a whole the particles have a greater mass and the efficiency of separation is improved by higher inertia forces.

According to the invention, upstream of the separator component a gas line though which additional gas can be supplied opens into the return line. The additional gas is preferably air wherein optionally also another gas can be supplied, for example, additional exhaust gas.

By means of supply of the additional gas, which has a lower temperature than the recirculated exhaust gas flow through the return line, a lower temperature is achieved overall by admixture of the recirculated exhaust gas so that a drop below the dew point is more easily achieved and the condensation is improved. Inasmuch as air is supplied through the gas line, an additional adjustable parameter for controlling the exhaust gas concentration is available also.

Moreover, an improved adaptation to different operating conditions of the internal combustion engine is possible. Depending on the actual operating state of the internal combustion engine, the quantity of the supplied gas proportion into the return line can be adjusted. For regulating the quantity, an adjustable control valve is expediently provided that is arranged in the gas line.

Mixing of the recirculated gas mass flow with the exhaust gas mass flow that is guided through the return line is realized preferably by means of a mixing component that is integrated into the return line. The gas line opens into the mixing component for mixing the gas proportion with the exhaust gas.

According to an advantageous embodiment, it is provided that the separator component is a cyclone separator. Such cyclone separators are characterized by a constructively simple and efficient configuration and can be installed even within a small mounting space. In the cyclone separator the separation of the particles that have been enlarged by condensed liquid is realized as a result of increased inertia forces.

In one embodiment, the separator component is arranged downstream of the mixing component. In a further embodiment, the mixing component is a mixing chamber that is integrated into the cyclone separator wherein in particular the separating section of the cyclone separator can be downstream of the mixing chamber in the flow direction.

The exhaust gas recirculation device comprises advantageously a controllable recirculation valve as well as an exhaust gas cooler that is integrated into the return line. By means of the recirculation valve the quantity of the exhaust gas mass flow through the return line can be adjusted. In the exhaust gas cooler, which is arranged upstream of the separator component as well as of the opening location of the gas line into the return line, the exhaust gas is cooled that is branched off the exhaust gas manifold and is at high temperature.

The internal combustion engine in which the exhaust gas recirculation device is used can be provided with an exhaust gas turbocharger which comprises a compressor in the intake manifold and an exhaust gas turbine in the exhaust gas manifold. In case of a diesel internal combustion engine, a diesel particulate filter, by means of which the soot particles in the exhaust gas are separated, is arranged downstream of the exhaust gas turbine in the exhaust gas manifold. The return line branches off downstream of the exhaust gas turbine and, in case of the diesel particulate filter, downstream of the latter. Particles which will detach from the exhaust gas purification unit usually configured as a particle filter and which pass into the return line are separated as described above in the separator component. In case of a diesel particulate filter, the latter comprises for example a ceramic body wherein, by means of the separator unit, it is prevented that accidentally detached ceramic particles can pass into a possibly present compressor and into the internal combustion engine.

The gas line that is opening into the return line branches off advantageously downstream of an air filter in the intake manifold. However, possible is also an embodiment in which by means of a gas line, separate from the intake manifold, additional gas, in particular ambient air, is to be supplied into the return line wherein optionally an additional air filter is integrated into the gas line.

In a further embodiment, a pumping device is provided in the gas line that opens into the return line and conveys the air from the intake manifold or, alternatively, from the environment into the exhaust gas return line. The pumping device can operate with uniform performance or can be controlled by means of an operating map.

In a further embodiment, a throttling device is provided in the intake manifold between the outflow location for the gas line and the inflow location for the return line of the exhaust gas recirculation device into the intake manifold in order to enhance the pressure drop between the intake manifold and exhaust gas recirculation device or between outflow location and inflow location at the intake manifold. The throttle device can be adjusted to a constant value or can be variably controlled according to a predetermined operating map.

In a method for operating the exhaust gas circulation device for an internal combustion engine, it is provided that the air mass flow that is to be supplied through the gas line is dependent on the actual load state and/or the engine speed of the internal combustion engine. It is particularly expedient to reduce, optionally down to zero, at low loads or low engine speeds the air mass flow to be supplied or another gas mass flow that passes through the gas line into the return line and to increase it at higher loads or higher engine speeds because in these operating states the cooling action of the recirculated exhaust mass flow by means of the exhaust gas cooler is possibly insufficient for generating a drop below the dew point.

### BRIEF DESCRIPTION OF THE DRAWINGS

Further advantages and expedient embodiments can be taken from the additional claims, the FIGURE description, and the drawing in which schematically an internal combustion engine with exhaust gas turbocharger and exhaust gas recirculation device is illustrated.

### DETAILED DESCRIPTION

The internal combustion engine 1 illustrated in the FIGURE is provided with an exhaust gas turbocharger 2 that comprise an exhaust gas turbine 3 in the exhaust gas manifold 4 and a compressor 5 in the intake manifold 6. The exhaust gas turbine 3 is driven by the pressurized exhaust gases of the internal combustion engine 1 wherein a compressor wheel in the compressor 5 is driven by means of a connecting shaft by the turbine wheel in the exhaust gas turbine 3 and the supplied combustion air in the intake manifold 6 is compressed to an increased charge pressure at which the combustion air is supplied to the cylinders of the internal combustion engine 1. In the intake manifold 6 an air filter 9 is arranged upstream of the compressor 5.

In the exhaust gas manifold 4 downstream of the exhaust gas turbine 3 a ceramic particle filter 7 is arranged by means of which soot particles entrained in the exhaust gas are separated. Moreover, downstream of the particle filter 7 in the exhaust gas manifold 4 an exhaust gas aftertreatment unit 8 is arranged.

Moreover, the internal combustion engine 1 is provided with an exhaust gas recirculation device 10 by means of which a partial mass flow of the exhaust gas is recirculated from the exhaust gas manifold 4 into the intake manifold 6. This is done in certain operating states of the internal combustion engine in order to improve the consumption behavior and exhaust gas behavior of the internal combustion engine.

The exhaust gas recirculation device 10 comprises a return line 11 that branches off downstream of the particle filter 7 from the exhaust gas manifold 4 and opens between the air filter 9 and the compressor 5 into the intake manifold 6. In the return line 11 there is an adjustable recirculation valve 12 as well as an exhaust gas cooler 13 by means of which the recirculated exhaust gas mass flow is cooled to lower temperatures. Moreover, downstream of the exhaust gas cooler 13 a cyclone separator 14 is integrated into the return line 11 wherein by means of the cyclone separator 14 particles that are entrained in the exhaust gas mass flow are separated. This is done by the inertia forces of the particles causing the latter to deposit in the cyclone separator 14 while the exhaust gas is further conveyed through the clean air outlet 18 of the cyclone separator 14 into the intake manifold 6. For improving the degree of separation, a condensation of moisture on the dirt particles in the recirculated exhaust gas mass flow downstream of the gas cooler 13 takes place. In this way, the particles are imparted with a considerably higher weight, which improves the separation in the cyclone separator.

For a further improvement of the efficiency of separation, a gas line 15 is provided which is branching off the intake manifold downstream of the air filter 9 but upstream of the opening location of the return line 11 into the intake manifold 6 and opens into a mixing unit 17 that is located in the return line 11 between the exhaust gas cooler 13 and the cyclone separator 14. Sucked-in ambient air that is filtered in the air filter 9 is returned through the gas line 15 from the intake manifold 6 and is passed in the area of the mixing unit 17 into the return line 11 and is mixed therein with the recirculated exhaust gas mass flow. Accordingly, the temperature of the exhaust gas will drop further so that in further operating areas a drop below the dew point may occur and a better condensation of moisture on the particles in the exhaust gas mass flow is achieved. As a result, the degree of separation in the cyclone separator 14 is improved also.

In the gas line 15 an adjustable control valve 16 is arranged in order to adjust the air mass flow through the gas line 15. It is in particular provided to set the proportion of the air mass flow through the gas line 15 as a function of the actual operating state of the internal combustion engine. The recirculated gas mass flow depends advantageously on the actual load state and/or the engine speed of the internal combustion engine, preferably in such a way that at low loads or engine speeds the air mass flow through the gas line 15 is reduced, optionally down to zero, and is increased at higher loads or engine speeds.

According to an alternative embodiment, illustrated in dashed line, the gas line 15 is embodied as a separate line that does not branch off the intake manifold but through which additional gas, in particular ambient air, is to be supplied to the return line wherein optionally an additional air filter 19 is integrated into the gas line 15.

1. An exhaust gas recirculation device for an internal combustion engine (1), comprising a return line (11) that branches off an exhaust gas manifold (4) of the internal combustion engine (1) and opens into an intake manifold (6) of the internal combustion engine (1), comprising a separator component (14) arranged in the return line (11), wherein upstream of the separator component (14) a gas line (15) opens into the return line (11), wherein by means of the gas line (15) additional gas, in particular air, can be supplied.

2. Exhaust gas recirculation device according to claim 1, wherein an adjustable control valve (16) is arranged in the gas line (15).

3. Exhaust gas recirculation device according to claim 1, wherein in the return line (11) a mixer component (17) is arranged into which the gas line (15) opens.

4. Exhaust gas recirculation device according to claim 1, wherein the separator component is embodied as a cyclone separator (14).

5. Exhaust gas recirculation device according to claim 1, wherein in the return line (11) an exhaust gas cooler (13) is arranged upstream of the separator component (14).

6. Exhaust gas recirculation device according to claim 1, wherein the return line (11) a controllable recirculation valve (12) is arranged upstream of the separator component (14).

7. An internal combustion engine with an exhaust gas recirculation device (10) according to claim 1.

8. Internal combustion engine according to claim 7, wherein the internal combustion engine (1) is provided with an exhaust gas turbocharger (2) with a compressor (5), wherein the return line (11) branches off the exhaust gas manifold (4) downstream of an exhaust gas turbine (3) and opens upstream of the compressor (5) into the intake manifold (6).

9. Internal combustion engine according to claim 7, wherein the gas line (15) branches off downstream of an air filter (9) in the intake manifold (6).

10. Internal combustion engine according to claim 7, wherein by means of the gas line (15) additional gas is to be introduced into the return line (11), separate from the intake manifold (6).

11. A method for operating an exhaust gas recirculation device (10) of claim 8 for an internal combustion engine (1), comprising:
controlling mass air flow supplied by the gas line (15) as a function of the actual load state or the engine speed of the internal combustion engine (1).

12. The method according to claim 11, wherein in the controlling step, mass air flow is controlled such that the air mass flow to be supplied is reduced at low loads or engine speeds and is increased at higher loads or engine speeds.
